(19) United States
(12) Patent Application Publication
(10) Pub. No.: US 2009/0296632 A1
(43) Pub. Date: Dec. 3, 2009

(54) NOVEL DISTRIBUTED BASE STATION ARCHITECTURE

(76) Inventors: Tuvia Apelewicz, Ra'anana (IL); Zohar Zeev Barzilai, Tel Aviv (IL)

Correspondence Address: Pearl Cohen Zedek Latzer, LLP, 1500 Broadway, 12th Floor, New York, NY, 10036, US

(21) Appl. No.: 12/093,596

(22) PCT Filed: Nov. 30, 2006
(86) PCT No.: PCT/IL06/01383

§ 371 Date: Jun. 3, 2009

Related U.S. Application Data
(60) Provisional application No. 60/740,992, filed on Nov. 30, 2005.

(51) Int. Cl. H04W 4/00

(52) U.S. Cl. 370/328

(57) ABSTRACT

A novel distributed base station architecture having a multiplexer. The base station transmits base station controller interface data over an internet protocol (IP) communication channel. The multiplexer receives the data and combines it with other base station controller interface data to form a single base station controller interface data signal.

### BACKGROUND OF THE INVENTION

This invention relates to cellular networks and more particularly to a method and apparatus using a multiplexer (MUX) and a de-multiplexer (DEMUX) to combine signals from multiple spatially placed base stations for overcoming deployment barriers, and for mobile coverage enhancement.

### DESCRIPTION OF THE RELEVANT ART

Deployment for mobile coverage of, third generation and beyond, cellular networks includes having a core network that is connected to base-station-controllers (BSC). The BSC, also known as radio-network-controller (RNC), is connected to, and controls, a multitude of base stations. Each base station contains at least one sector, and each sector connects to and controls cellular phones that are within its radio coverage area. The communication channel between the base-station-controller and each base station is unique and dedicated to said base station and will be referred herein to as lub communication channel. The lub communication channel enables the exchange of control, management, and traffic data between the base station and the base-station-controller. The base-station-controller has limited resources and can control only limited amount of individual base stations. Thus a problem exists in deploying a base-station-controller that controls a massive amount of base stations.

### SUMMARY OF INVENTION

A general object of the invention is a distributed base station cellular network having a multiplexer (MUX) for combining several base stations lub channels into one base-station-controller lub channel, and a de-multiplexer (DEMUX) for the distribution of one base-station-controller lub channel onto several base stations lub channels, thus enhancing the capacity of the base-station-controller.

According to the present invention, as embodied and broadly described herein, a novel distributed base station architecture is provided comprising a DEMUX, a base station sector transmitter, a base station sector receiver, and a MUX. We will refer herein to each base station sector as ZCell. The DEMUX includes a network-interface device, delay device, address-generator device, and an internet-protocol-interface device. The network-interface device receives the base-station-controller-demux (BSCDlub) data signal from the base-station-controller and generates the demultiplexer-lub-transport-block (DlubTB) data signal. The delay device delays the DlubTB data signal and generates the delayed-demux-lub-transport-block (DDlubTB). The address-generator device generates the Internet-protocol-ZCell-address (IPZAD) data signal. The internet-protocol-interface device combines IPZAD signal and DDlubTB signal and generates the ZCell-lub-over-internet-protocol (ZlubIP) data signal.

The ZCell transmitter includes an internet-protocol-interface device, a processor, channel-element means, a radio-frequency-up-converter, a power amplifier, a combiner, and an antenna. The internet-protocol-interface device receives the ZlubIP data signal and generates the ZCell-lub-transport-block-data (ZlubTBD) signal. The processor generates the transmitted-traffic-data (TTD) signal. The channel-element means generate the transmitted-base-band-modulated-traffic-data (TBBMTD) signal. The radio-frequency-up-converter (RFUC) generates the transmitted-radio-frequency-modulated-traffic-data (TRFMTD) signal. The power-amplifier generates the amplified-transmitted-radio-frequency-modulated-traffic-data (ATRFMTD) signal. The combiner filters the ATRFMTD signal and generates the filtered-amplified-transmitted-radio-frequency-modulated-traffic-data (FATRFMTD) signal. And the antenna radiates the FATRFMTD signal over a communication channel.

The ZCell receiver includes an antenna, a combiner, a radio-frequency-down-converter (RFDC) device, channel-element means, a processor, and an internet-protocol-interface device. The antenna couples the ZCell receiver to the communication channel. The combiner separates the received-radio-frequency-modulated-traffic-data (RRFMTD) signal from other non receiver out-of-band signals and outputs the filtered-received-radio-frequency-modulated-traffic-data (FRRFMTD) signal to the radio-frequency-down-converter (RFDC) device. The RFDC generates the received-base-band-modulated-traffic-data (RBBMTD) signal. The channel-element means generate the received-traffic-data (RTD) signal. The processor generates the lub-transport-block (lubTB) data signal. The internet-protocol-interface device adds internet protocol packets overhead and framing to the lubTB data signal, and generates the mux-lub-over-Internet-protocol (MlubIP) data signal.

The MUX includes an internet-protocol-interface device, delay device, combiner, and a network-interface device. The internet-protocol-interface device receives the MlubIP data signal from the lub communication channel and generates the mux-lub-transport-block (MlubTB) data signal. The delay device generates the delayed-mux-lub-transport-block (DMlubTB) data signal. The combiner linearly combines DMlubTB data signals to generate the combined-lub-transport-block (ClubTB) data signal. The network-interface device generates the base-station-controller-mux-lub (BSCMlub) data signal.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF DRAWINGS

The accompanying drawings, which are incorporated in and constitute a part of the specifications, illustrate preferred embodiments of the invention, and together with the description serve to explain the principles of the invention. Wherein like reference numbers indicate like elements in the several views.

FIG. 1 is a block diagram of the DEMUX device.

FIG. 2 is a block diagram of the ZCell transmitter;

FIG. 3 is a block diagram of the MUX with combiner;

FIG. 4 is a block diagram of the ZCell receiver;

FIG. 5 is a block diagram of the distributed base station;

FIG. 6 is a block diagram of the combiner circuit; and

FIG. 7 is a frame format of the combiner output.

### DETAILED DESCRIPTION OF THE PREFERRED EMBODIMENTS

Reference now is made in detail to the present preferred embodiments of the invention, examples of which are illustrated in the accompanying drawings.

The present invention provides a novel distributed base station architecture including a DEMUX and MUX for use in cellular systems. The novel base station architecture includes one or more base stations, one or more DEMUXES, and one or more MUXES. The following discussion focuses on a base station, a DEMUX and a MUX, with the understanding that multiple base stations, multiple DEMUXES, and multiple MUXES can be used in a system.

### DEMUX

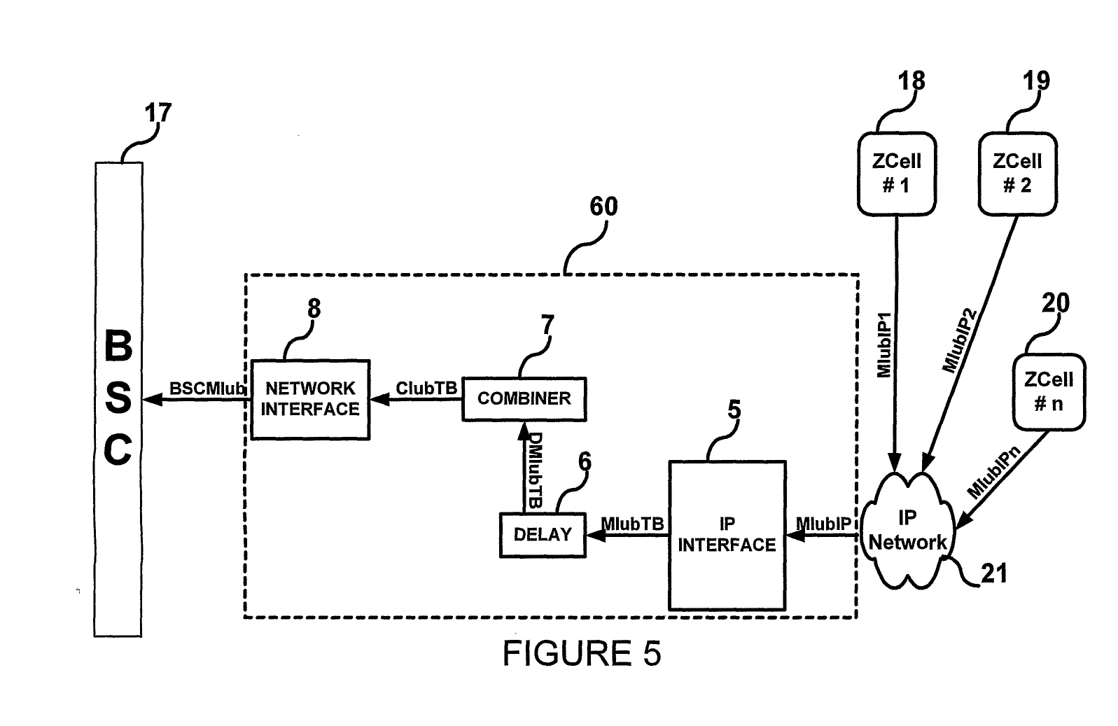

The DEMUX 40 includes a network-interface device 1, a delay device 2, address-generator device 3, and an internet-protocol-interface device 4. The base-station-controller 17 is coupled to the network-interface device 1 as shown in FIG. 5. The network-interface 1 is coupled to the delay device 2. The internet-protocol-interface device 4 is coupled to the address-generator device 3 and to the delay device 2.

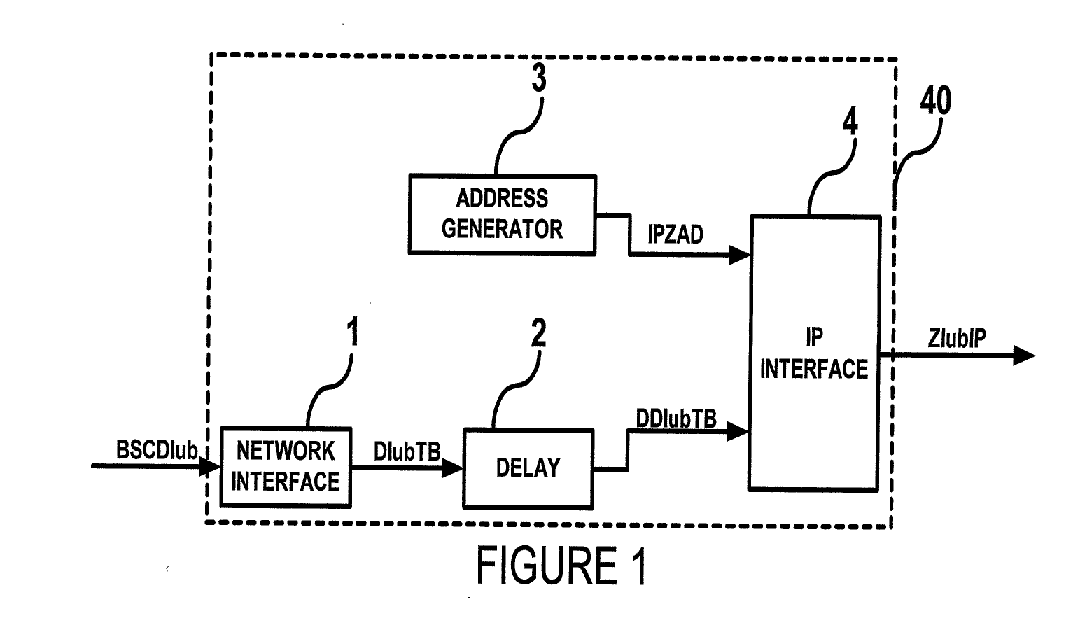

The network-interface device 1 receives base-station-controller-demux-lub data from the base-station-controller 17. The main function of the network-interface device 1 is to terminate the communication channel with the base-station-controller 17. The physical communication channel, between the network-interface device 1 and the base-station-controller 17, and the associated protocols are well known in the art, and as such so is the network-interface device 1. The network-interface device 1 generates demultiplexer-lub-transport-block (DlubTB) data signal. The delay device 2 delays in time said DlubTB data signal and generates the demultiplexer-delayed-lub-transport-block (DDlubTB) data signal. The address-generator 3, as shown in FIG. 1, retrieves the destination ZCell internet protocol (IP) address and generates the internet-protocol-ZCell-address (IPZAD) data signal. The address-generator device 3 may include shift registers with appropriate taps, as is well known in the art, for generating the particular address data signal. The address-generator device 3 alternatively may be embodied as, or as part of, a digital signal processor (DSP), or application specific integrated circuit (ASIC). Construction of DSPs and ASICs, and their use, are well known in the art. The address-generator device 3 alternatively may include a memory for storing the internet-protocol-ZCell-address data signal, and outputting the internet-protocol-ZCell-address data signal. The memory may be constructed from discrete components, or as part of a DSP or ASIC.

The present invention may have more than one address-generator device 3 so that said demultiplexed-delayed-lub-transport-block data signal can be delivered to more than one ZCell transmitters.

The internet-protocol-interface device 4 combines said internet-protocol-ZCell-address to said demultiplexer-delayed-lub-transport-block data signal and generates the ZCell-lub-internet-protocol (ZlubIP) data signal intended for the destination ZCell. The main function of said internet-protocol-interface device 4 is to terminate the internet protocol (IP) communication channel between said DEMUX 40 and the ZCell transmitter 50. The internet protocol (IP) communication channel is well known in the art, and as such so is said internet-protocol-interface device 4.

### ZCell Transmitter

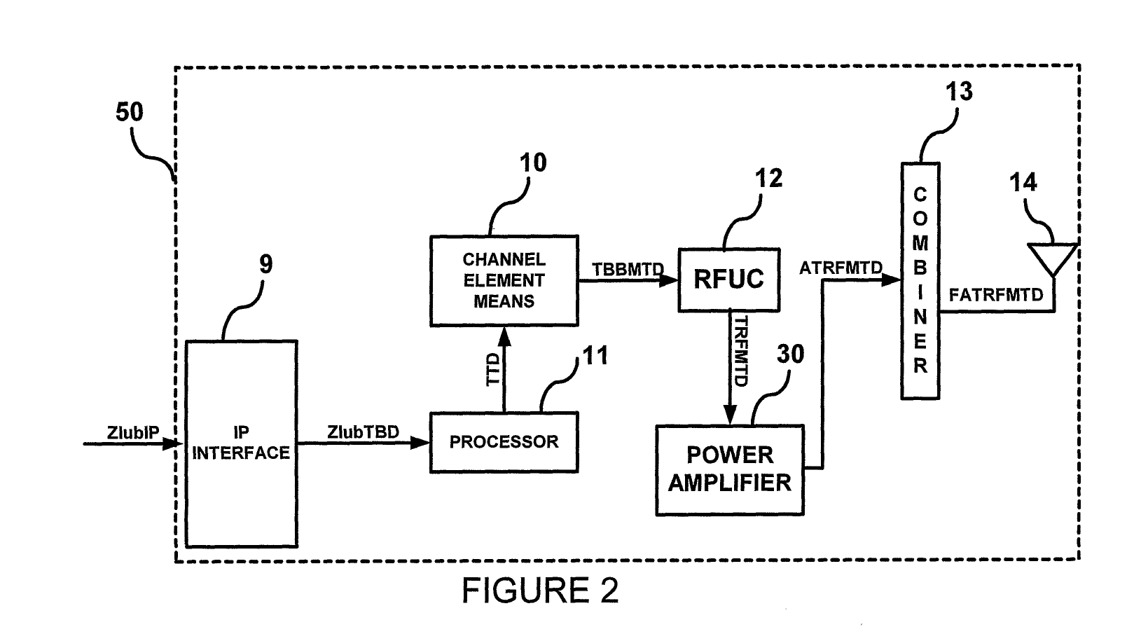

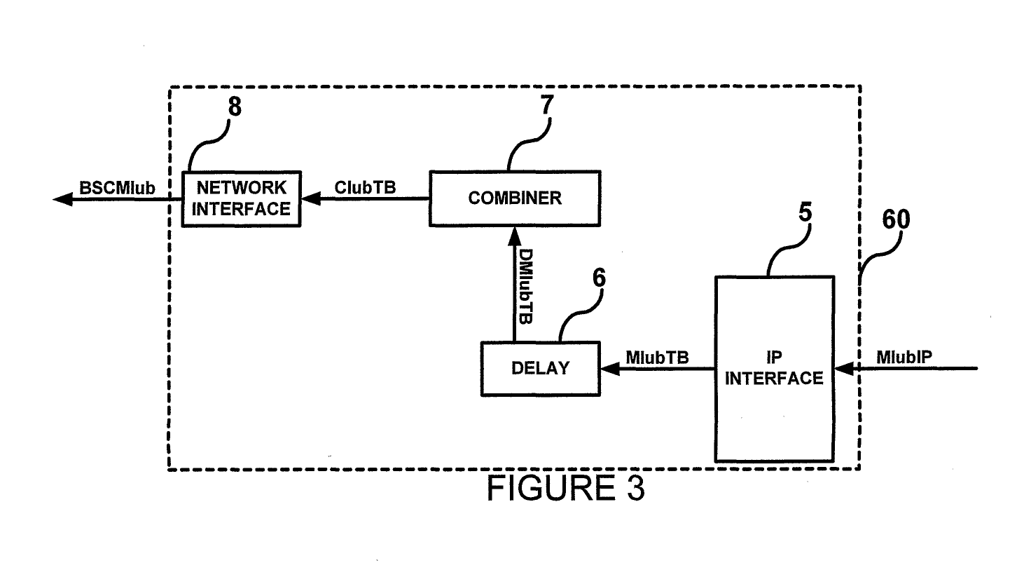

The ZCell transmitter 50, as shown in FIG. 2, includes an internet-protocol-interface device 9, a processor 11, channel-element means 10, a radio-frequency-up-converter device 12, a power amplifier 30, a combiner 13, and a transmitter antenna 14. The internet-protocol-interface device 9 is coupled to the processor 11. The processor 11 is coupled to channel-element means 10. The channel-element means 10 is coupled to the radio-frequency-up-converter device 12. The radio-frequency-up-converter 12 is coupled to the power amplifier 30. The transmitter antenna 14 is coupled through the combiner 13 to the power amplifier 30. The internet-protocol-interface device 9 receives said ZCell-lub-over-internet-protocol (ZlubIP) data signal and generates the ZCell-lub-transport-block-data (ZlubTBD) signal. The main function of the internet-protocol-interface device 9 is to terminate the internet protocol (IP) communication channel between the ZCell transmitter 50 and said DEMUX 40. The internet protocol (IP) communication channel is well known in the art, and as such so is said internet-protocol-interface device 9. The processor 11 generates the transmitted-traffic-data (TTD) signal. The processor 11 may be embodied as, or as part of, a digital signal processor (DSP), or application specific integrated circuit (ASIC). Construction of DSPs and ASICs, and their use, are well known in the art. The processor 11 may include a memory for storing ZCell transmitter 50 control functions. The memory may be constructed from discrete components, or as part of a DSP or ASIC. The channel-element means 10 main function is to generate a modulated base-band-spread-spectrum signal according to third generation standards which are well known in the art. A single channel-element means is defined in the art as the processing power needed to maintain a single voice communications session. The channel-element means 10 generates the transmitted-base-band-modulated-traffic-data (TBBMTD) signal. The channel-element means 10 may include shift registers with appropriate taps, as is well known in the art, for generating said TBBMTD signal. The channel-element means 10 alternatively may be embodied as, or as part of, a digital signal processor (DSP), or application specific integrated circuit (ASIC). Construction of DSPs and ASICs, and their use, are well known in the art. The channel-element means 10 alternatively may include a memory. The memory may be constructed from discrete components, or as part of a DSP or ASIC.

The radio-frequency-up-converter (RFUC) device 12 generates the transmitter-radio-frequency-modulated-traffic-data (TRFMTD) signal. The radio-frequency-up-converter device 12 is well known in the art.

The power-amplifier 30 amplifies said TRFMTD signal and generates the amplified-transmitted-radio-frequency-modulated-traffic-data (ATRFMTD) signal. The combiner 13 filters said ATRFMTD signal and generates the filtered-amplified-transmitted-radio-frequency-modulated-traffic-data (FATRFMTD) signal. The output of combiner 13 is radiated by the transmitter antenna 14, which sends said FATRFMTD signal over a communication channel.

### ZCell Receiver

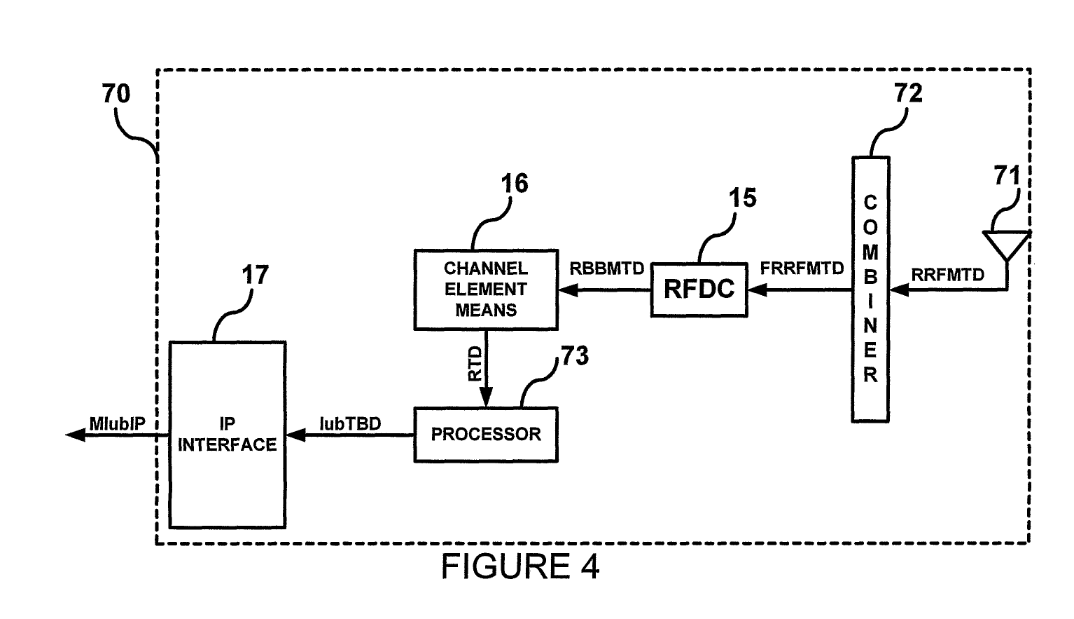

The ZCell receiver 70, as shown in FIG. 4, includes a receiver antenna 71, a combiner 72, a radio-frequency-down-converter device 15, channel-element means 16, a processor 73, and an internet-protocol-interface device 17. The receiver antenna 71 is coupled through the combiner 72 to the radio-frequency-down-converter 15. The radio-frequency-down-converter 15 is coupled to channel-element means 16. The channel-element means 16 is coupled to processor 73. The processor 73 is coupled to the internet-protocol-interface device 17.

The receiver antenna 71 couples the ZCell receiver 70, to the communication channel. The combiner 72 separates the received-radio-frequency-modulated-traffic-data (RRFMTD) signal from other non receiver out-of-band signals and outputs the filtered-received-radio-frequency-modulated-traffic-data (FRRFMTD) signal to the radio-frequency-down-converter (RFDC) device 15. The radio-frequency-down-converter device 15 generates the received-base-band-modulated-traffic-data (RBBMTD) signal. The radio-frequency-down-converter device 15 is well known in the art. The channel-element means 16 main function is to demodulate a base-band-spread-spectrum signal according to third generation standards which are well known in the art. A single channel-element means is defined in the art as the processing power needed to maintain a single voice communications session. The channel-element means 16 generate the received-traffic-data (RTD) signal. The channel-element means 16 may include shift registers with appropriate taps, as is well known in the art, for demodulating said RBBMTD signal. The channel-element means 16 alternatively may be embodied as, or as part of, a digital signal processor (DSP), or application specific integrated circuit (ASIC). Construction of DSPs and ASICs, and their use, are well known in the art. The channel-element means 16 alternatively may include a memory. The memory may be constructed from discrete components, or as part of a DSP or ASIC.

The processor 73 generates the lub-transport-block (lubTB) data signal. The processor 73 may be embodied as, or as part of, a digital signal processor (DSP), or application specific integrated circuit (ASIC). Construction of DSPs and ASICs, and their use, are well known in the art. The processor 73 may include a memory for storing ZCell receiver 70 control functions. The memory may be constructed from discrete components, or as part of a DSP or ASIC.

The internet-protocol-interface device 17 adds internet protocol packets overhead and framing to said lubTB data signal, and generates the mux-lub-over-Internet-protocol (MlubIP) data signal. The main function of the internet-protocol-interface device 17 is to transmit over the internet protocol (IP) communication channel between the ZCell receiver 70 and the MUX 60. The internet protocol (IP) communication channel is well known in the art, and as such so is the internet-protocol-interface device 17.

### MUX

The MUX 60 includes an internet-protocol-interface device 5, a delay device 6, a combiner 7, and a network-interface device 8. The internet-protocol-interface device 5 receives said MlubIP data signal from said ZCell receiver device 70 over the lub communication channel. The main function of the internet-protocol-interface device 5 is to terminate the internet protocol (IP) communication channel between the MUX 60 and said ZCell receiver 70, and to generate the mux-lub-transport-block (MlubTB) data signal. The internet protocol (IP) communication channel is well known in the art, and as such so is the internet-protocol-interface device 5.

The delay device 6 delays in time said MlubTB data signal and generates the delayed-mux-lub-transport-block (DMlubTB) data signal. The delay device 6 may include shift registers with appropriate taps, as is well known in the art, for delaying in time said MlubTB data signal. The delay device 6 alternatively may be embodied as, or as part of, a digital signal processor (DSP), or application specific integrated circuit (ASIC). Construction of DSPs and ASICs, and their use, are well known in the art. The delay device 6 alternatively may include a memory. The memory may be constructed from discrete components, or as part of a DSP or ASIC.

Combiner 7 receives said DMlubTB data signal and generates the combined-lub-transport-block (ClubTB) data signal.

The present invention may include additional delay devices for delaying additional said MluTB data signals that are associated with a multitude of ZCell receiver devices. By way of example, the invention may include up to n delay devices as shown in FIGS. 5 & 6.

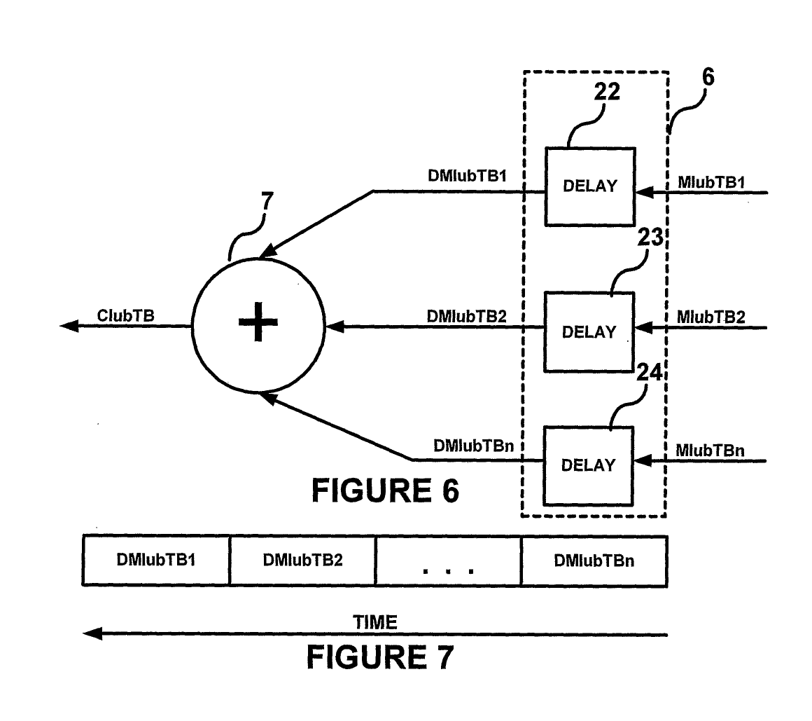

Combiner 7 is coupled to delay devices 22, 23, and 24 as shown in FIG. 6. The internet-protocol-interface device 5 receives the mux-lub-ove-internet-protocol-1 (MlubIP1) data signal generated by ZCell #1 device 18 and generates the mux-lub-transport-block-1 (MlubTB1) data signal. The internet-protocol-interface device 5 also receives the mux-lub-ove-internet-protocol-2 (MlubIP2) data signal generated by ZCell #2 device 19 and generates the mux-lub-transport-block-2 (MlubTB2) data signal. The internet-protocol-interface device 5 also receives the mux-lub-ove-internet-protocol-n (MlubIPn) data signal generated by ZCell #n device 20 and generates the mux-lub-transport-block-n (MlubTBn) data signal. Delay device 22 receives said MlubTB1 data signal and generates the delayed-mux-lub-transport-1 (DMlubTB1) data signal. Delay device 23 receives said MlubTB2 data signal and generates the delayed-mux-lub-transport-2 (DMlubTB2) data signal. Delay device 24 receives said MlubTBn data signal and generates the delayed-mux-lub-transport-n (DMlubTBn) data signal. Combiner 7 generates the combined-lub-transport-block (ClubTB) data signal. The said ClubTB data signal frame and content is shown in FIG. 7.

The network-interface device 8 generates the base-station-controller-mux-lub (BSCMlub) data signal. The main function of the network-interface device 8 is to terminate the communication channel with the base-station-controller 17. The physical communication channel, between the network-interface device 8 and the base-station-controller 17, and the associated protocols are well known in the art, and as such so is the network-interface device 8.

It will be apparent to those skilled in the art that various modifications can be made to the novel distributed base station architecture of the instant invention without departing from the scope or spirit of the invention, and it is intended that the present invention cover modifications and variations of the novel distributed base station architecture provided they come within the scope of the appended claims and their equivalents.

1.-3. (canceled)

4. A method for enhancing coverage and capacity of a cellular network comprising:
receiving Iub data signals from a plurality of cellular base stations;
generating delayed Iub signals by delaying in time the Iub data signals;
combining the delayed Iub signals and generating a combined Iub signal; and
transferring the combined Iub signal to a base station controller.

5. The method of claim 4, further comprising:
receiving an Iub data signal from the base station controller;
generating a plurality of delayed signals by delaying in time the Iub data signal;
generating address signals, each corresponding to an address of one of the cellular base stations;
generating a plurality of Iub data signals, each intended for one of the base stations by combining for each of the delayed signals a respective one of the address signals.

6. The method of claim 4, wherein the Iub data signals are transferred over Internet Protocol (IP) communication channel.

7. The method of claim 4, wherein the delayed Iub data signals are generated by more than one delay module.

8. The method of claim 4, wherein the combined Iub signal contains the delayed Iub signals in consecutive order.

9. The method of claim 4, wherein the base station controller is a radio-network-controller.

10. The method of claim 5, further comprising:
transferring the Iub data signals over an IP communication channel.

11. The method of claim 5, wherein each of the address signals comprises an IP address of one of the base stations.

12. A system for enhancing coverage and capacity of a cellular network comprising:
a multiplexer to receive a plurality of Iub data signals from a plurality of cellular base stations and to generate a combined Iub data signal, wherein the multiplexer comprises:
a first delay device to receive the Iub data signals and to generate a plurality of delayed Iub signals; and
a combiner to combine the delayed Iub signals and to generate the combined Iub signal to be transferred to a base station controller.

13. The system of claim 12, further comprising:
a demultiplexer to receive an Iub data signal from the base station controller and to generate another plurality of Iub data signals, wherein the demultiplexer comprises:
a second delay device to generate another plurality of delayed signals by delaying in time the Iub data signal;
an address generator to generate a plurality of address signals, each corresponding to an address of one of the base stations; and
an interface module to generate the other plurality of Iub data signals, each intended for one of the base stations, by combining for each of the delayed signals a respective one of the address signals.

14. The system of claim 12, wherein the Iub data signals are transferred over Internet Protocol (IP) communication channel.

15. The system of claim 12, wherein the multiplexer comprises an IP interface to receive the Iub data signals from the cellular base stations.

16. The system of claim 12, wherein the delay device comprises a plurality of delay modules, each to receive one of the Iub data signals and to generate a delayed Iub signal.

17. The system of claim 12, wherein the combined Iub signal contains the delayed Iub signals in consecutive order.

18. The system of claim 12, wherein the multiplexer comprises a network interface to transfer the combined Iub signal to the base station controller.

19. The system of claim 12, wherein the base station controller is a radio-network-controller.

20. The system of claim 13, wherein the demultiplexer comprises a network interface to receive the Iub data signal from the base station controller.

21. The system of claim 13, wherein each of the address signals comprises an IP address of one of the base stations.

22. The system of claim 13, wherein the interface module is an IP interface module.
